(19) United States
(12) Patent Application Publication
(10) Pub. No.: US 2024/0162701 A1
(43) Pub. Date: May 16, 2024

(54) SURGE PROTECTIVE DEVICE AND METHOD, AND AN ELECTRIC SYSTEM WITH SAID PROTECTIVE DEVICE

(71) Applicant: PROLEC, S. A. DE C. V., Apodaca (MX)

(72) Inventor: David Omar CARDENAS AGUILERA, Apodaca (MX)

(21) Appl. No.: 18/500,246

(22) Filed: Nov. 2, 2023

Related U.S. Application Data
(60) Provisional application No. 63/424,691, filed on Nov. 11, 2022.

(51) Int. Cl. H02H 3/22; H01C 7/12; H02H 9/04

(52) U.S. Cl. CPC H02H 3/22; H01C 7/126; H02H 9/042

(57) ABSTRACT

A surge protection device and method for protecting an electric system against overvoltage occurrences, the surge protection device includes a first surge arrester and a second or additional surge arresters connected electrically in parallel, the first surge arrester and the second surge arrester are configured to be disconnected from the electric system in a sequential predetermined order as each one is overloaded and becomes unusable as a surge arrester, remaining the electric system protected until the last one is disconnected. Various combination of externally gapped, internally gapped, and ungapped surge arresters are used to create the uninterruptable protection in the electric system.

### CROSS REFERENCE TO RELATED APPLICATIONS

The present application claims priority to U.S. Provisional Application No. 63/424,691, filed Nov. 11, 2022, entitled “Surge Protective Device and Method, and an Electric System with said Protective Device”, which is incorporated herein by reference.

### TECHNICAL FIELD OF THE INVENTION

This invention relates to the field of surge arresters that drain to ground surges due to lightning strokes and that are installed in electric power distribution lines of medium and high voltage, and more precisely, relates to a surge protection device having a first surge arrester and a second surge arrester electrically connected in parallel to provide a uninterrupted protection by disconnecting from the electric system in a sequential predetermined order as each one is overloaded and becomes unusable as a surge arrester.

### BACKGROUND OF THE INVENTION

Surge arresters currently used to mitigate lightning surges and are installed in power transmission lines of medium and high voltage are generally formed by a plurality of varistors connected by way of a column, an upper electrode connected to the upper end of the column of varistors, a lower electrode connected to the lower end of the column of varistors, a fiberglass layer surrounding the varistor column, a polymeric insulating housing surrounding the fiberglass layer.

The varistors provide either a high or a low impedance current path between the electrodes depending on the voltage appearing across the varistors themselves. More specifically, at the power system's steady state or normal operating voltage, the varistors have a relatively high impedance. As the applied voltage is increased, gradually or abruptly, the varistors' impedance progressively decreases until the voltage appearing across the varistors reaches the elements' breakdown voltage, at which point their impedance dramatically decreases and the varistors become highly conductive. Accordingly, if the surge arrester is subjected to an abnormally high transient overvoltage, such as resulting from a lightning strike or power frequency overvoltage for example, the varistors become highly conductive and serve to conduct the resulting transient current to ground. As the transient overvoltage and resultant current dissipate, the varistors' impedance once again increases, restoring the arrester and electrical system to their normal, steady-state condition.

Occasionally, the transient condition may cause some degree of damage to one or more of the varistors. Damage of sufficient severity can result in arcing within the insulating housing, leading to a short circuit within the arrester. The ground lead disconnector attached to the ground end of the arrester operates and isolates the arrester from the circuit. When this occurs, the equipment the arrester was protecting is no longer protected.

Surge protection of valuable equipment from the effects of lightning and switching surges has been a standard practice for more than a century. In all these years, a single arrester on each phase has been installed near the equipment to provide the desired protection. In substations, if an arrester fails, it is standard practice to isolate the arrester as well as the protected equipment from the circuit and replace it as soon as possible. While the failed arrester and unprotected equipment await maintenance, they are quite well protected by an overhead shield or terminal pole as well as isolation switches. In this case no equipment goes unprotected. On distribution lines where arresters are installed near a distribution transformer or other equipment, the failure scenario is quite different. In this case, if an arrester fails, its ground lead disconnector operates to isolate the arrester from the circuit. This is so there is less down time for the customers. Once the ground lead disconnector isolates the arrester from the circuit, the protected transformer becomes unprotected until a maintenance team installs a new arrester. This unprotected time period can range from a few hours to years. In areas with high lightning density, the risk of failure of the unprotected equipment is quite high and failure is quite possible. In areas of low lightning levels, the risk is much lower. This risk level is easily calculated using methods shown in IEEE 1410-2010.

It is known in prior art that installing two surge arresters in parallel is effective in reducing the energy absorbed by each surge arrester if these surge arresters have the same discharge voltage and the same voltage-current characteristics, see H. Sugimoto, A. Asakawa, S. Yokoyama and K. Nakada, “Effectiveness of Installing Two Pairs of Distribution Surge Arresters in Parallel,” 1999 Eleventh International Symposium on High Voltage Engineering, vol. 2, pp. 246-249, 1999; C. A. Christodoulou, V. Vita and T. I. Maris, “Lightning Protection of Distribution Substations by Using Metal Oxide Gapless Surge Arresters Connected in Parallel,” International Journal of Power and Energy Research, vol. 1, no. 1, pp. 1-7, 2017; and Y. Trotsenko, V. Brzhezitsky and V. Mykhailenko, “Estimation of Discharge Current Sharing Between Surge Arresters with Different Protective Characteristics Connected in Parallel”, 2020 IEEE 7th International Conference on Energy Smart Systems (ESS), pp. 73-78, May. 2020. This matching of the characteristics of both surge arresters permits to achieve an adequate sharing of the lightning current between the surge arresters and the reducing residual voltage. However, if the lightning current exceeds the capability of this arrangement, both surge arresters will likely fail and the electric system becomes unprotected until a maintenance team installs a new arrester.

Accordingly, there exists a need in the art for a surge protection device which, upon failure, will fail in such a way that protection for the electric system is not lost. Preferably, such a surge protection device would eliminate the possibility of interrupted protection by transferring the protection capabilities from a first surge arrester to a second surge arrester and successively. One means by which this may be accomplished is to design an improved surge protection device which would disconnect the failed surge arrester while keeping the redundant unfailed arrester in service.

### BRIEF DESCRIPTION OF THE FIGURES

Other features of the present invention will become apparent from the following detailed description considered in connection with the accompanying drawings. It should be understood, however, that the drawings are made only as an illustration and not as a limitative definition of the invention, in which:

FIG. 1 illustrates a first embodiment of a surge protection device according to the invention.

FIG. 2 illustrates a second embodiment of a surge protection device according to the invention.

FIG. 3 illustrates a third embodiment of a surge protection device according to the invention.

FIG. 4 illustrates a fourth embodiment of a surge protection device according to the invention.

FIG. 5 illustrates a fifth embodiment of a surge protection device according to the invention.

FIG. 6 illustrates a sixth embodiment of a surge protection device according to the invention.

FIG. 7 illustrates a first embodiment of an electric system adapted to be subjected to voltages according to the invention.

FIG. 8 illustrates a second embodiment of an electric system adapted to be subjected to voltages according to the invention.

FIG. 9 is a schematic flow chart illustrating an embodiment of the method for protecting an electric system against overvoltage occurrences according to the present invention.

### DETAILED DESCRIPTION OF THE INVENTION

Term “overload” is used, in the context of this description, to describe the end-of-life event of a surge arrester without calling it a failure or otherwise. It is a term that means the surge arrester went through the process of drawing too much current, possibly blew a hole in the side of the unit and in the end its ground lead disconnector operates and isolates the unit from the circuit.

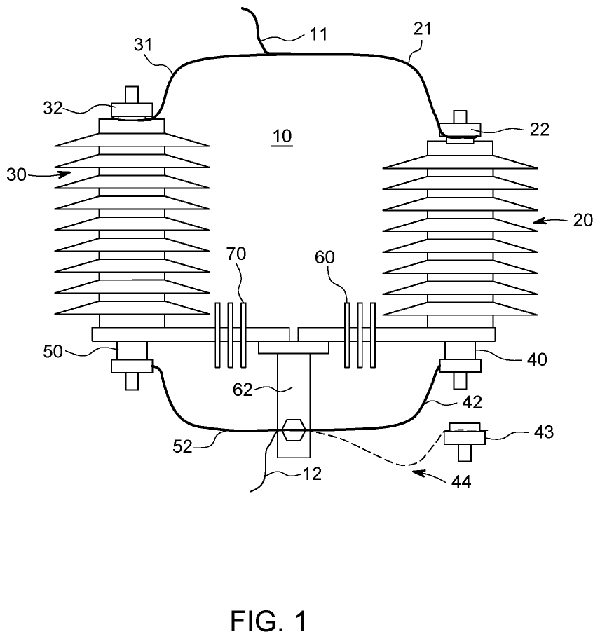

FIG. 1 illustrates a first embodiment of a surge protection device according to the invention. The surge protection device 10 comprises a first surge arrester 20 and second surge arrester 30. Line leads 21 and 31 connect the first surge arrester 20 and the second surge arrester 30 top terminals 22 and 32 to an electric system 11 to be protected. Ground leads 42 and 52 connects the first surge arrester 20 and the second surge arrester 30 ground lead disconnectors 40 and 50 to a ground 12. The first surge arrester 20 and the second surge arrester 30 are configured to be disconnected from the electric system 11 in a sequential predetermined order as each one is overloaded and becomes unusable as a surge arrester, keeping the electric system 11 protected until the last one is disconnected.

Insulating hanger 60 attached to first surge arrester 20. Insulating hanger 70 attached to second surge arrester 30. Mounting bracket 62 supports first surge arrester 20 and second surge arrester 30. Second surge arrester 30 in this embodiment may or may not be physically taller than first surge arrester 20, this is because it contains a different varistor column internally that has different electrical characteristics than first surge arrester 20. In this embodiment, second surge arrester 30 has a higher conduction turn on level and possibly a higher protective level than first surge arrester 20. This difference is set specifically so that when the voltage rises on the electric system 11 to which they are attached, first surge arrester 20 is predetermined to start to conduct the surge before second surge arrester 30. Second surge arrester 30 may or may not conduct at all depending on the amplitude of the surge. If the surge is high enough, it can cause both first surge arrester 20 and second surge arrester 30 to conduct.

In all overvoltage occurrences, first surge arrester 20 will conduct more current and dissipate more energy than second surge arrester 30. If the surge is above the capability of first surge arrester 20, it will fail and cause the ground lead disconnector 40 to operate. When ground lead disconnector 40 operates, it disconnects the ground lead 42 from the bottom terminal of first surge arrester 20. This disconnection results in displacing the ground lead 42 to its post failure location 44. The ground lead disconnector 40 also is displaced and its final location will be similar to ground lead disconnector 43. During this event the current that may have been flowing through second surge arrester 30 is reduced to a low level well below the current level that would cause damage to it. After the first surge arrester 20 becomes unusable as a surge arrester, second surge arrester 30 remains in service and will protect the electric system 11 it serves. There is no protection interruption for the protected insulation. Second surge arrester 30 will remain in service until becomes unusable as a surge arrester or until it is removed from the circuit.

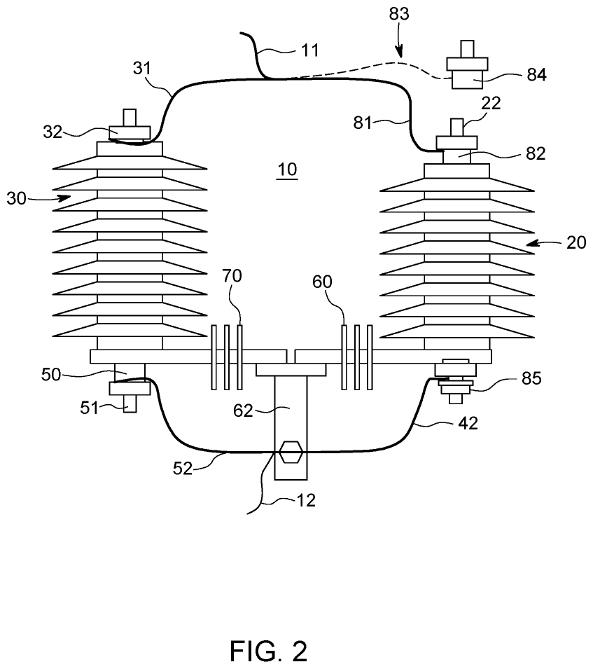

FIG. 2 illustrates a second embodiment of a surge protection device according to the invention. Surge protection device 10 comprises a first surge arrester 20 and second surge arrester 30. Line leads 81 and 31 connect the first surge arrester 20 and the second surge arrester 30 top terminals 22 and 32 to an electric system 11 adapted to be subjected to voltages to be protected, the top terminal 22 of the first surge arrested 20 is connected to a line lead disconnector 82. Ground leads 42 and 52 connects the first surge arrester 20 and the second surge arrester 30 bottom terminals 85 and 51 to a ground 12, the bottom terminal 51 of the second surge arrester 30 is connected to a ground lead disconnector 50. The first surge arrester 20 and second surge arrester 30 are designed so that the discharge voltage and voltage-current characteristics are different.

First surge arrester 20 and second surge arrester 30 are supported mechanically by insulating hangers 60 and 70 which are supported by mounting bracket 62. The bottom terminal of first surge arrester 20 is a passive electrical terminal 85 which is connected to ground 12 by ground lead 43. First surge arrester 20 and second surge arrester 30 are connected at their upper end by line leads 81 and 31 which in turn are connected to an electric system 11 adapted to be subjected to voltages. Line lead 81 connects to line lead disconnector 82 that is attached to the upper terminal 22 of first surge arrester 20. In the event of an overvoltage of first surge arrester 20 that has a lower turn on voltage by design and more likely to overload than second surge arrester 30, the line lead disconnector 82 operates and separates line lead 81 from the top terminal of first surge arrester 20. Line lead 83 and line lead disconnector 84 illustrate how the surge protection device 10 might be configured after an overvoltage of first surge arrester 20.

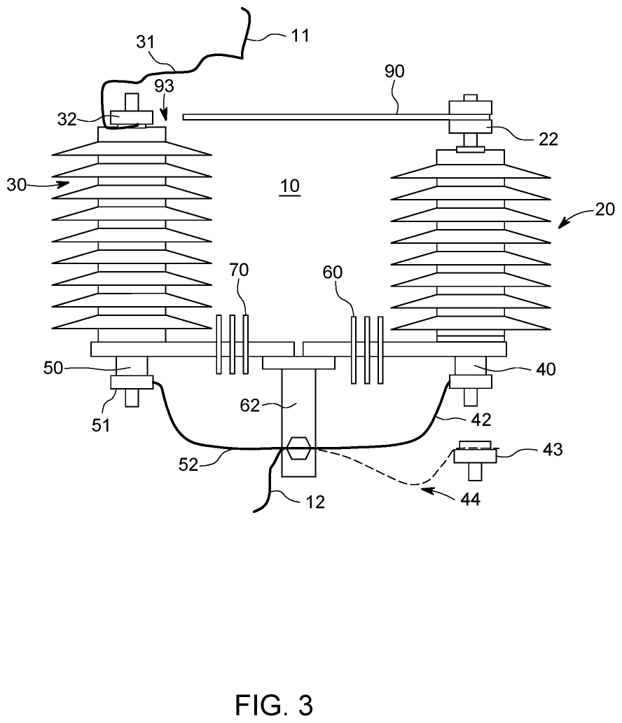

FIG. 3 illustrates a third embodiment of a surge protection device according to the invention. Surge protection device 10 comprises a first surge arrester 20 and second surge arrester 30. This embodiment is similar to FIG. 1 except the line lead 21 is replaced with a conductive electrode 90 connected to upper terminal 22 and with series air gap 93. The first surge arrester 20 and second surge arrester 30 are designed so that the discharge voltage and voltage-current characteristics are different. The fundamental difference is the turn on voltage of each arrester 20 and 30. The levels are set so that when a surge or temporary overvoltage appears on the electric system 11 adapted to be subjected to voltages being protected. In this embodiment, the first surge arrester 20 is an externally gapped arrester which will conduct before the second surge arrester 30 which is controlled by the size of air gap 93. If a surge level higher than the capability of first surge arrester 20 strikes the electric system 11, and first surge arrester 20 becomes unusable as a surge arrester, ground lead disconnector 40 will operate and indicate that first surge arrester 20 is no longer functional.

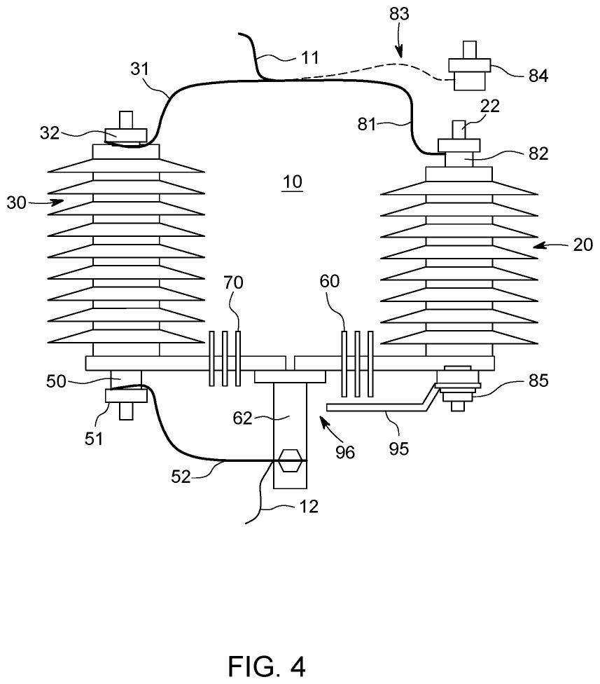

FIG. 4 illustrates a fourth embodiment of a surge protection device according to the invention. Surge protection device 10 comprises a first surge arrester 20 and second surge arrester 30. The first surge arrester 20 and second surge arrester 30 are designed so that the discharge voltage and voltage-current characteristics are different. This embodiment is similar to FIG. 2 except the ground lead 42 is replaced with a conductive electrode 95 with series air gap 96 on the end near mounting bracket 62 and directly connected to first surge arrester 20 bottom terminal 85. Series air gap 96 is comprised of the conductive electrode 95 and ground electrode in the mounting bracket 62 and is set so that it will sparkover before first surge arrester 20 begins significant conduction, which then channels a major share of the surge protection device 10 is handling.

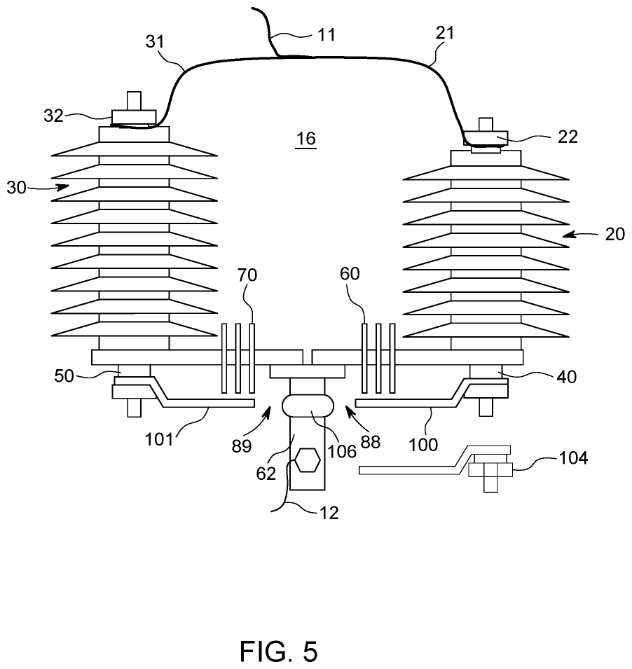

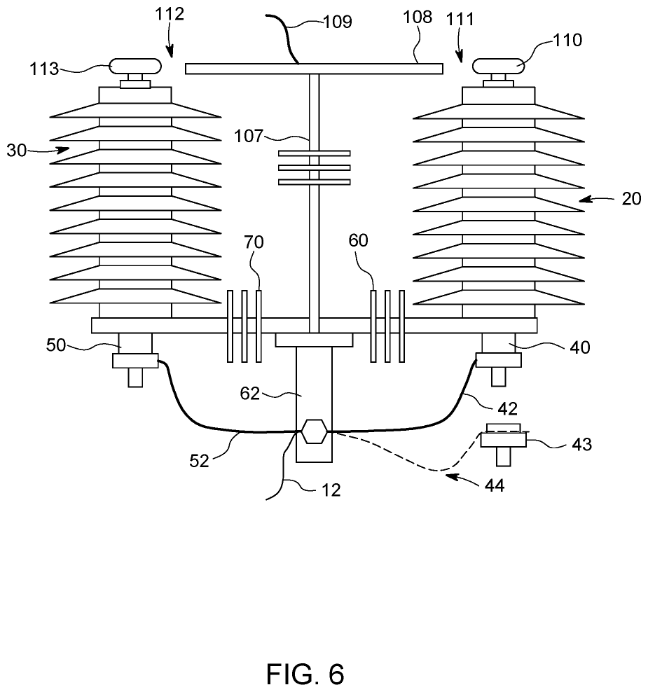

FIG. 5 illustrates a fifth embodiment of a surge protection device according to the invention. Surge protection device 10 comprises a first surge arrester 20 and second surge arrester 30. The first surge arrester 20 and second surge arrester 30 are designed so that the discharge voltage and voltage-current characteristics are different. This embodiment is similar to FIG. 1 except the ground leads 42 and 52 are replaced with conductive electrodes 100 and 101, respectively. A third electrode 106 is attached to mounting bracket 62 to create air gaps 88 and 89 with the conductive electrodes 100 and 101, respectively. Air gaps 88 and 89 can be similar or different depending on the characteristics of the first sure arrester 20 and second surge arrester 30. Ground lead disconnector assembly 104 will drop away from the assembly indicating a failed first surge arrester 20 if the first surge arrester 20 becomes unusable as a surge arrester FIG. 6 illustrates a sixth embodiment of a surge protection device according to the invention. Surge protection device 10 comprises a first surge arrester 20 and second surge arrester 30. The first surge arrester 20 and second surge arrester 30 are designed so that the discharge voltage and voltage-current characteristics are different. The first surge arrester 20 and second surge arrester 30 are externally gapped arresters because air gaps 111 and 112 are in series with first surge arrester 20 and second surge arrester 30, respectively. Air gaps 111 and 112 can be identical in dimensions or different depending on the design and the characteristics of first surge arrester 20 and second surge arrester 30 which also may or may not be identical. Conductive electrode 108 is supported by insulating bracket 107 and is connected to the power system through line lead 109. Electrodes 110 and 113 serve as the arrester top end electrode and can be identical or different again depending on the characteristics of the arresters and the desired operating sequence of surge protection device 10.

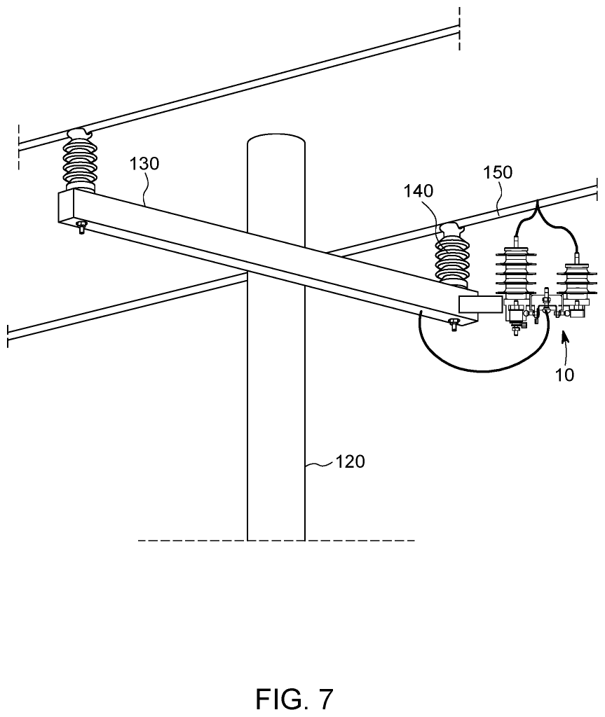

FIG. 7 illustrates a first embodiment of an electric system electric system adapted to be subjected to voltages according to the invention. The electric system 11 includes an electric pole 120; a conductive support 130 attached to the electric pole 120 and electrically connected to a ground; an insulator 140 attached to the support 130; an electric power distribution line 150 supported by the insulator 140; and a surge protection device 10 attached to the support 130 and connected to the electric power distribution line 150 and the ground.

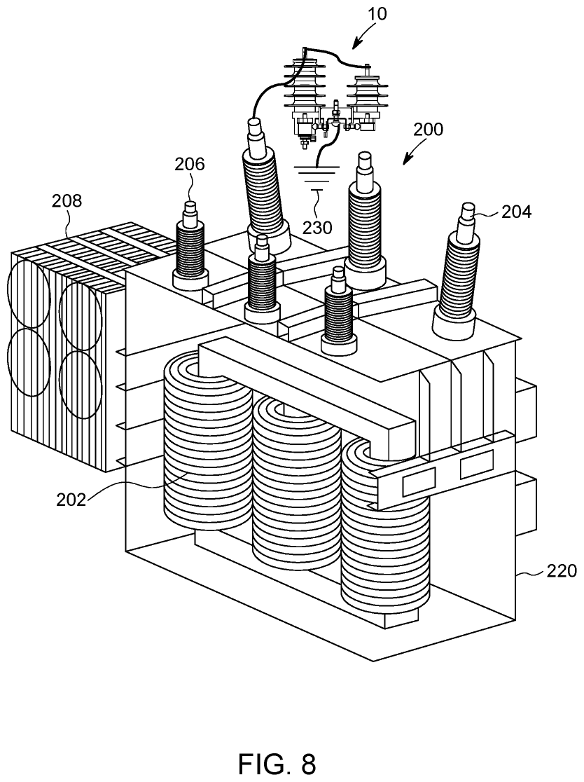

FIG. 8 illustrates a second embodiment of an electric system electric system adapted to be subjected to voltages according to the invention. The electric system 11 includes an electric transformer 200 including three transformer phases 202 that are disposed within a system housing 220, but optionally may be a single-phase transformer system having a single transformer phase. One or more of the transformer phases 202 includes a high-voltage bushing 204 and a low voltage bushing end 206 that extend outside and away from the system housing 220. A surge protection device 10 is connected to a high-voltage bushing 204 and the ground 230. One or more cooling systems 208 operably coupled with the electric transformer 200 are configured to cool the temperature of the electric transformer 200.

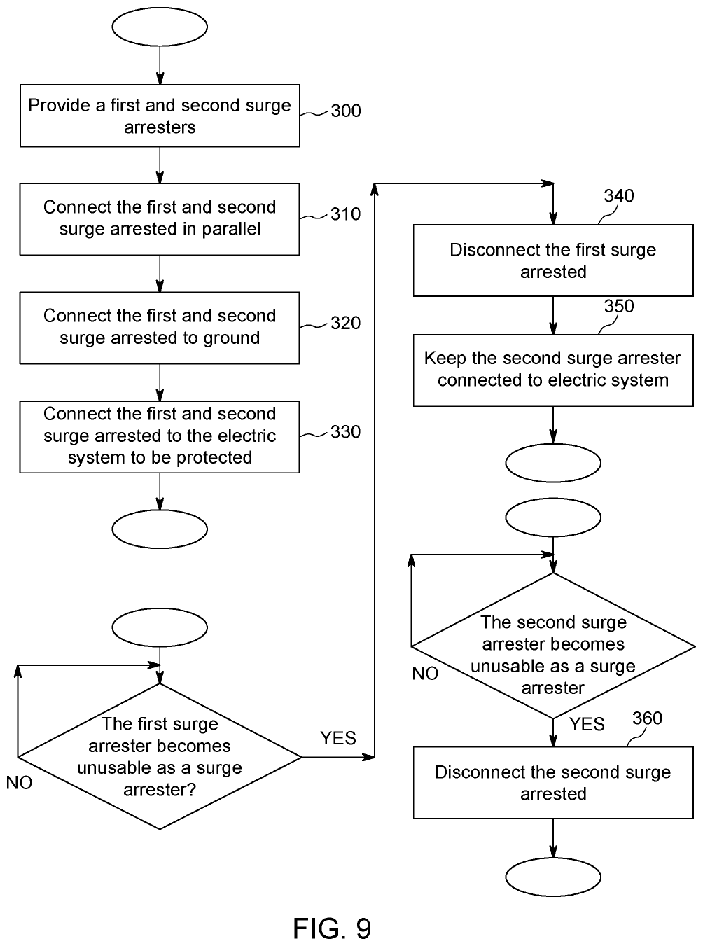

FIG. 9 is a schematic flow chart illustrating an embodiment of the method for protecting an electric system against overvoltage occurrences according to the present invention. The method comprising the following steps: providing a first surge arrester and a second surge arrester, the first surge arrester has dissimilar discharge voltage and voltage-current characteristics in relation to the second surge arrester, said discharge voltage and voltage-current characteristics of each one of first surge arrester and second surge arrester are in compliance with the protection characteristics required for the electric system to be protected, and the first surge arrester is predetermined to start to conduct the current before the second surge arrester when an overvoltage occurs in the electric system, at step 300. Connecting the first surge arrester and the second surge arrester in parallel, at step 310. Connecting the first surge arrester and the second surge arrester to ground, at step 320. Connecting the first surge arrester and the second surge arrester to the electric system, at step 330. Disconnecting the first surge arrester when it is overloaded and becomes unusable as a surge arrester, at step 340; and the second surge arrester remains connected when the first surge arrester is disconnected, at step 350. Disconnecting the second surge arrester when it is overloaded and becomes unusable as a surge arrester, at step 360.

In another embodiment of the present invention, the surge protection device includes more than two surge arresters connected in parallel, and each surge arrester conducts part of a surge when the surge reaches the terminals of the surge protection device. If any one of the surge arresters is overloaded during or after the surge, it will be disconnected from the circuit keeping all the remaining surge arresters to continue protecting the electric system from transient overvoltages.

Another embodiment of the invention is where the surge arrester uses current limiting technology to protect the electric system from overvoltage occurrences. In this embodiment, surge arresters can have similar or dissimilar voltage/current characteristics.

Further embodiments of the invention are where the surge protection device is isolated upon an overload by using a ground lead disconnector, a separate device from the surge arrester body (such as a fuse or other), an electronic or mechanical switch, and combinations thereof.

If the surge arrester is mounted in a dropout form that can be changed or replaced with a hot stick from a bucket truck or the ground or elsewhere, it too can be set up to sequentially operate when parallel units are also installed in the same or different manner.

Although the present invention has been described by way of particular embodiments and examples thereof, it should be noted that it will be apparent to persons skilled in the art that modifications may be applied to the present particular embodiment without departing from the scope of the present invention.

1. A surge protection device for protecting an electric system against overvoltage occurrences, the surge protection device comprising:
a first surge arrester;
a second surge arrester electrically connected in parallel to the first surge arrester;
wherein the first surge arrester and the second surge arrester are connectable to ground and to the electric system which is to be protected; and
wherein the first surge arrester and the second surge arrester are configured to be disconnected from the electric system in a sequential predetermined order as each one is overloaded and becomes unusable as a surge arrester, keeping the electric system protected until the last one is disconnected.

2. The surge protection device of claim 1, wherein the first surge arrester has similar or dissimilar discharge voltage and voltage-current characteristics in relation to the second surge arrester, and said discharge voltage and voltage-current characteristics of each one of first surge arrester and second surge comply with the protection characteristics required for the electric system to be protected.

3. The surge protection device of claim 1, wherein the electric system is selected from the group of an electric power generation system, an electric power transmission system, an electric power distribution line, an electric transformer and electric reactor.

4. The surge protection device of claim 1, wherein the either or both surge arresters are connectable to the electric system to be protected with a conductor or indirectly through an air gap.

5. The surge protection device of claim 1, wherein the either or both surge arresters are connectable to the ground with a conductor or indirectly through an air gap.

6. The surge protection device of claim 1, wherein the second surge arrester is connectable to the electric system to be protected with a conductor or indirectly through an air gap.

7. The surge protection device of claim 1, wherein the second surge arrester is connectable to the ground with a conductor or indirectly through an air gap.

8. The surge protection device of claim 1, wherein the first surge arrester is arranged to be disconnected from the electric system when it is overloaded and becomes unusable as a surge arrester, and the second surge arrester is arranged to remain connected when the first surge arrester is disconnected.

9. The surge protection device of claim 1, wherein the second surge arrester is arranged to be disconnected from the electric system when it is overloaded and becomes unusable as a surge arrester.

10. An electric system adapted to be subjected to voltages comprising:
an electric distribution transformer having at least one high-voltage bushing; and
a surge protection device comprising:
a first surge arrester;
a second surge arrester electrically connected in parallel to the first surge arrester;
wherein the first surge arrester and the second surge arrester are connected to a ground and to the high-voltage bushing;
wherein the first surge arrester and the second surge arrester are configured to be disconnected from the electric distribution transformer in a sequential predetermined order as each one is overloaded and becomes unusable as a surge arrester, keeping the electric distribution transformer protected until the last one is disconnected.

11. The electric system of claim 10, wherein the first surge arrester is connected to the high-voltage bushing with a conductor or indirectly through an air gap.

12. The electric system of claim 10, wherein the first surge arrester is connected to the ground with a conductor or indirectly through an air gap.

13. The electric system of claim 10, wherein the second surge arrester is connected to the high-voltage bushing with a conductor or indirectly through an air gap.

14. The electric system of claim 10, wherein the second surge arrester is connected to the ground with a conductor or indirectly through an air gap.

15. The electric system of claim 10, wherein the first surge arrester is arranged to be disconnected from the electric distribution transformer when it is overloaded and becomes unusable as a surge arrester, and the second surge arrester is arranged to remain connected when the fist surge arrester is disconnected.

16. The electric system of claim 10, wherein the second surge arrester is arranged to be disconnected from the electric distribution transformer when it is overloaded and becomes unusable as a surge arrester.

17. A method for protecting an electric system against overvoltage occurrences, the method comprising the steps of:
providing a first surge arrester and a second surge arrester;
connecting the first surge arrester and the second surge arrester in parallel;
connecting the first surge arrester and the second surge arrester to ground;
connecting the first surge arrester and the second surge arrester the electric system;
disconnected the first surge arrester and the second surge arrester from the electric system in a sequential predetermined order as each one is overloaded and becomes unusable as a surge arrester; and
keeping the electric system protected until the last one of the first surge arrester and the second surge arrester is disconnected.

18. The method of claim 17, wherein in the step of providing a first surge arrester and a second surge arrester, the first surge arrester has similar or dissimilar discharge voltage and voltage-current characteristics in relation to the second surge arrester, said discharge voltage and voltage-current characteristics of each one of first surge arrester and second surge compliance with the protection characteristics required for the electric system to be protected, and the first surge arrester is predetermined to start to conduct the current before the second surge arrester when an overvoltage occurs in the electric system.

19. The method of claim 17, wherein further includes the steps of:
disconnect the first surge arrester from the electric system when the first surge arrester is overloaded and becomes unusable as a surge arrester; and
remaining connected the second surge arrester when the first surge arrester is disconnected.

20. The method of claim 19, wherein further includes the step of:
disconnect the second surge arrester from the electric system when the second surge arrester is overloaded and becomes unusable as a surge arrester.

21. A surge protection device for protecting an electric system against overvoltage occurrences, the surge protection device comprising:
two or more surge arresters electrically connected in parallel;
wherein said surge arresters are connectable to ground and to the electric system which is to be protected; and
wherein the surge arresters are configured to be disconnected from the electric system in a sequential predetermined order as each one is overloaded and becomes unusable as a surge arrester, remaining the electric system protected until the last one is disconnected.

22. The surge protection device of claim 21, wherein each surge arrester is isolated upon an overload by a ground lead disconnector.

23. The surge protection device of claim 21, wherein each surge arrester is isolated upon an overload by a separate device from the surge arrester body such as a fuse or other.

24. The surge protection device of claim 21, wherein each surge arrester is isolated upon an overload by an electronic or mechanical switch.

25. The surge protection device of claim 21, wherein each surge arrester uses current limiting technology to protect the electric system from overvoltage occurrences.

26. The surge protection device of claim 21, wherein the surge arresters have similar or dissimilar discharge voltage and voltage-current characteristics between them.
